(19) United States
(12) Patent Application Publication
(10) Pub. No.: US 2023/0363407 A1
(43) Pub. Date: Nov. 16, 2023

(54) UNWRAPPED HARD CANDY PRODUCT; ISOMALT CONFECTIONERY; METHOD OF MAKING AND USE THEREOF

(71) Applicant: INTERCONTINENTAL GREAT BRANDS LLC, East Hanover, NJ (US)

(72) Inventors: Clive R. Norton, East Hanover, NJ (US); Khyati A. Jindal, East Hanover, NJ (US); Mine Oztekin, East Hanover, NJ (US); William M. Polak, East Hanover, NJ (US)

(21) Appl. No.: 18/028,648

(22) PCT Filed: Sep. 28, 2021
(86) PCT No.: PCT/US2021/052292

§ 371 Date: Mar. 27, 2023

Related U.S. Application Data
(60) Provisional application No. 63/089,711, filed on Oct. 9, 2020.
(60) Provisional application No. 63/210,327, filed on Jun. 14, 2021.

(51) Int. Cl. A23G 3/42; A23G 3/48

(52) U.S. Cl. CPC A23G 3/42; A23G 3/48

(57) ABSTRACT

Disclosed are hard isomalt compositions and hard isomalt confectionery products having enhanced shelf stability. Further disclosed herein is a packaged plurality of unwrapped hard candy product comprising a container and a plurality of unwrapped hard candy product units. The unwrapped hard candy product units comprise a hydrophobic lubricant, a polyol having an equilibrium relative humidity less than 50%, wherein the unwrapped hard candy product units have non-cohesive surface tack, an accelerated shelf life of greater than five weeks, and a microcrystalline outer layer disposed around an amorphous center. Weight percent is based on the total weight of the hard candy product units. Also described is a method of making the packaged plurality of unwrapped hard candy product units.

### CROSS REFERENCE TO RELATED APPLICATIONS

This application claims priority to U.S. Provisional Application No. 63/089,711, filed Oct. 9, 2020, and U.S. Provisional Application No. 63/210,327, filed Jun. 14, 2021, the disclosures of which are incorporated herein by reference in their entirety for all purposes.

### BACKGROUND

Hard boiled candies, also known as hard sweets or boiled sweets, are solid and essentially amorphous or “glassy” confectionery products obtained by extensive dehydration of carbohydrate syrups to a low moisture content. Hard-boiled candies can be sugar-based or sugar-free. Sugar-based hard boiled candies are made by boiling a mixture of sugar, glucose syrup and water to a moisture content of around two percent. Sugar-free hard boiled candies can be prepared by boiling a mixture of a sugar polyol (alditol) and water, or melting sugar polyols without water, and optionally with a sugar polyol syrup.

Hard candies are typically individually wrapped. The wrapping represents an inconvenience when consuming the candy, a use of natural resources, and a need to dispose of a wrapper each time a candy is consumed. In addition, hard candies are typically designed to be consumed one at a time and are relatively large, around 3 grams. This limits portion control, thus much smaller candies, which permit discretion in the amount consumed, are desirable

The shelf stability of a hard boiled candy product can depend upon the type of bulk sweetener used. Use of hygroscopic bulk sweeteners result in products that adsorb ambient moisture, which can lead to crystal formation, graining, whitening or discoloration, and softening of the product due to lowering of the glass transition temperature. Less hygroscopic bulk sweeteners resist the adsorption of moisture from the surroundings.

Sugar-based hard boiled candies are known to absorb moisture leading to graining, loss of translucency, and stickiness. Less hygroscopic bulk sweeteners resist the adsorption of moisture from the surroundings. Isomalt is a sugar-free sugar polyol possessing a hygroscopicity that is lower than most other sugar polyols and lower than sugar itself. Isomalt absorbs little moisture at room temperature and relatively high humidity. Isomalt's low hygroscopicity minimizes stickiness during forming, cutting and wrapping and results in a product that, after piece formation, resists sticking and exhibits a longer shelf life than sugar-based hard candy products. Despite isolmalt's low hygroscopicity, stickiness remains an issue when the product is not individually wrapped. Isomalt is also reported to be more resistant to acid and enzymatic hydrolysis than comparable sugars.

Besides bulk sweetener type, other ingredients added to a hard boiled candy may affect product stability, particularly if the ingredient is highly hygroscopic or causes a reaction with the bulk sweetener or another ingredient.

There remains a need in the art for hard candy having enhanced stability during storage, a need for methods of enhancing the shelf life of a hard candy product, and a need for methods for reducing or minimizing crystal formation, graining, whitening or discoloration, and softening of a hard candy product during storage.

The is a further need for unwrapped hard candy to provide convenience, no piece of paper to dispose of, and less packaging. It is also desirable to make smaller products, less than one gram, to permit portion control.

### SUMMARY

In an embodiment, a hard candy product comprises isomalt, a flavorant, and optionally an additional ingredient, wherein the hard candy product is free of ethanol and propylene glycol, or substantially free of ethanol, propylene glycol, or both ethanol and propylene glycol.

In an embodiment, a hard candy product comprises isomalt, a flavorant, and optionally an additional ingredient, wherein the hard candy product is free of ethanol and propylene glycol, or substantially free of ethanol, propylene glycol, or both ethanol and propylene glycol, and further free of glycerol or further substantially free of glycerol.

In an embodiment, a hard candy product comprises isomalt, a flavorant, and optionally an additional ingredient, wherein the hard candy product is free of linear and branched chain C₁-C₅ alkyl alcohol (mono-, di-, and triol) or substantially free of linear and branched chain C₁-C₅ alkyl alcohol (mono-, di-, and triol).

In an embodiment, a method of preparing a hard candy product comprises cooking a mixture of isomalt and water, optionally under vacuum, to achieve a moisture content at or below 4 wt. %, specifically at or below 3 wt. % based on the total weight of the cooked mass, or melting isomalt to form a cooked mass; cooling the cooked mass and adding the flavorant and optional additional ingredient with mixing to form a melt; forming the melt into the hard candy product, wherein the hard candy product is free of ethanol and propylene glycol, or substantially free of ethanol, propylene glycol, or both ethanol and propylene glycol.

In another embodiment, a method of extending the shelf life of an isomalt hard candy comprises using a flavorant in the isomalt hard candy composition, wherein the flavorant is free of ethanol and propylene glycol, or substantially free of ethanol, propylene glycol, or both ethanol and propylene glycol; optionally the flavorant is further free of glycerol or further substantially free of glycerol.

In another embodiment, a method of extending the shelf life of an isomalt hard candy comprises using a flavorant in the isomalt hard candy composition, wherein the flavorant is free of linear and branched chain C₁-C₅ alkyl alcohol (mono-, di-, and triol) or substantially free of linear and branched chain C₁-C₅ alkyl alcohol (mono-, di-, and triol).

In an embodiment is a packaged plurality of unwrapped hard candy product comprising a container comprising a moisture barrier material or packaged within a moisture barrier material; and a plurality of unwrapped hard candy product units. The unwrapped hard candy product units comprise a hydrophobic lubricant and a polyol having an equilibrium relative humidity less than 50%, wherein the unwrapped hard candy product units have non-cohesive surface tack, an accelerated shelf life of greater than five weeks, and a microcrystalline outer layer disposed around an amorphous center. The polyol may have a hygroscopicity of less than or equal to 10% at room temperature and 60% relative humidity.

In another embodiment is a packaged plurality of unwrapped hard candy product, comprising: a container and a plurality of unwrapped hard candy product units housed within the container. The hard candy product comprises greater than or equal to 90 wt % isomalt, flavorant, and 0.01 to 1 wt % MCT oil, and has a moisture content of less than or equal to 4 wt. %, specifically less than or equal to 3 wt. %. Each unit of hard candy product has a weight of less than or equal to 1 gram, specifically 0.2 to 0.8 gram, and more specifically 0.5 to 0.7 gram, and a microcrystalline outer layer disposed around an amorphous center. Weight percent is based on the weight of the hard candy product unit.

In an embodiment a method of making a packaged plurality of unwrapped hard candy product, the method comprises forming a plurality of unwrapped hard candy product units comprising a hydrophobic lubricant and a polyol having an equilibrium relative humidity less than 50%; conditioning the plurality of unwrapped hard candy product units at a relative humidity which is equal to the equilibrium relative humidity of the polyol+/−20%, specifically the equilibrium relative humidity of the polyol+/−10%, and at 18 to 28° C. , specifically 20 to 25° C. for up to 4 days, specifically 24 to 72 hours; and packaging the unwrapped hard candy product units in a container, the container comprises a moisture barrier material or is packaged within a moisture barrier material. The polyol may have a hygroscopicity of less than or equal to 10% at room temperature and 60% relative humidity.

The above described and other features are exemplified by the following detailed description.

### BRIEF DESCRIPTION OF THE DRAWING

The following descriptions should not be considered limiting in any way. With reference to the accompanying drawings, like elements are numbered alike:

FIG. 1 shows an apparatus for forming hard candy product.

### DETAILED DESCRIPTION

A detailed description of one or more embodiments of the disclosed composition, product, apparatus, and method are presented herein by way of exemplification and not limitation with reference to the Figure.

Providing unwrapped hard candy has problems with both cohesiveness of individual pieces and crystallization (or whitening) of the surface. These issues are believed to be caused by increased exposure of the unwrapped surface to the environment due to the absence of the wrapping. This seems to be exacerbated by making the candy much smaller than typical. Not wishing to be bound by theory, but the difficulty with smaller pieces may in part be due to higher shear when making the candy and higher surface area to volume ratio, which may affect the amount of additive near the surface. It has been found that adding a hydrophobic lubricating agent and/or conditioning the formed candy resolves the issues. It is believed that the hydrophobic additive reduces shear stresses and shear induced crystallization during processing and the additive at or near the surface reduces environmental moisture contact with the surface, thus reducing crystallization. Additionally, conditioning at the proper conditions, as defined below, creates microcrystals on the surface which are invisible to the unaided eye and creates a non cohesive surface.

Disclosed herein is a container of unwrapped hard candy product comprising a hydrophobic lubricant and a polyol having an equilibrium relative humidity less than 50% at room temperature, wherein the unwrapped hard candy product has non-cohesive surface tack, an accelerated shelf life of greater than five weeks when housed in a container comprising a moisture barrier material or a container packaged within a moisture barrier material, and a microcrystalline outer layer disposed around an amorphous center. Accelerated shelf life is determined at 37° C.+/−2° C. and 80%+/−5% relative humidity. A more detailed description of the testing is found in the Examples. Non-cohesive surface tack is defined as the individual pieces of candy remaining as discrete unwrapped product (not adhering to one another) after being subjected to the conditions for determining accelerated shelf life for five weeks. The polyol may have a hygroscopicity of less than or equal to 10% at room temperature (25° C.) and 60% relative humidity.

Short shelf life and stickiness are two issues which are problematic with individually unwrapped hard candies, particularly with sugar free hard candies having an individual weight less than or equal to 1 gram. Surprisingly, the introduction of a hydrophobic lubricant to the bulk composition had a positive impact on both the stickiness (tack) of the unwrapped candies and on the shelf life. The hydrophobic lubricant is present in the bulk composition and is not applied to the surface of the hard candies in a separate application step. The hydrophobic lubricant, in combination with the selection of a polyol with particular characteristics (low hygroscopicity and/or low equilibrium relative humidity) and conditioning of the hard candies, yielded an unwrapped candy that had non-cohesive tack and an accelerated shelf life of greater than five weeks when a plurality of the individually unwrapped hard candies are housed in a container comprising a moisture barrier material or a container packaged within a moisture barrier material. This was even more surprising because even hard candies having an individual weight less than or equal to 1 gram exhibited these characteristics. As is recognized in the art small hard candy products are more susceptible to issues of stickiness and reduced shelf life. Shelf life is the duration of time the hard candies retain their surface appearance without whitening or color fade as determined by visual inspection using the naked eye.

The candies demonstrated a microcrystalline outer layer disposed on an amorphous center. A microcrystalline layer comprises crystals having a size less than 100 microns, or less than 50 microns, or less than 25 microns, or less than or equal to 20 microns. The microcrystalline layer may comprise crystals such that greater than or equal to 75%, or greater than or equal to 85%, or greater than or equal to 90% of the crystals have a size less than 100 microns, or less than 50 microns, or less than 25 microns or less than or equal to 20 microns. The microcrystalline layer may consist of crystals having a size less than 100 microns, specifically less than 50 microns, and more specifically less than 25 microns or less than or equal to 20 microns. The crystal size of the microcrystalline outer layer is such that whitening or color fade is not visible to the naked eye. Whitening is sometimes referred to as crystallization which is different from microcrystallization due to the difference in crystal size (physical property) and optical properties. Without being bound by theory, it is believed that the presence of a microcrystalline layer at the surface of the hard candies reduces stickiness and enhances shelf life. The combination of hydrophobic lubricant, a polyol with low equilibrium relative humidity and optionally low hygroscopicity, and conditioning, as described below, contribute to the formation of the microcrystalline layer and permit the formation of small hard candies (less than 1 gram) with long shelf life and which can be packaged without having to wrap the individual products.

Exemplary hydrophobic lubricants include beeswax, candelilla wax, carnauba wax, shellac, paraffins, mineral oil, petrolatum, petroleum wax (microcrystalline wax, paraffin wax), gum benzoic, crystalline wax, rice bran wax, spermaceti wax, wax esters, methyl esters of fatty acids, montanic acid esters, lanolin, oxidized polyethylene wax, esters of colophony, medium chain triglyceride oil (MCT oil) and combinations of the foregoing. In some embodiments, the hydrophobic lubricant consists of MCT oil.

MCT oil includes a mixture of triglycerides of saturated fatty acids, mainly of caprylic acid and of capric acid, containing not less than 95% of saturated fatty acids; Medium Chain Triglycerides (CAS No. 65381-09-1/73398-61-5); or triglycerides having the following structural formula

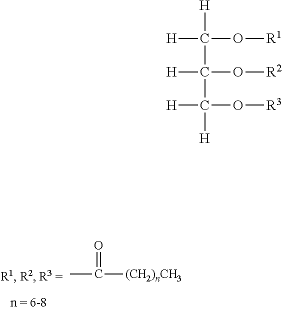

The hydrophobic lubricant is included in the hard candy product in an amount to minimize sticking and promote shelf life. Exemplary amounts of hydrophobic lubricant can be about 0.01 to about 1.0 wt. % based on the total weight of the product, specifically about 0.05 to about 0.9 wt. %, more specifically about 0.1 to about 0.7 wt. %, and yet more specifically about 0.15 to 0.6 wt. %.

The polyol of the unwrapped hard candies has an equilibrium relative humidity less than 50% at room temperature (low equilibrium relative humidity). The polyol may have a hygroscopicity of less than or equal to 10% at room temperature and 60% relative humidity (low hygroscopicity). Exemplary polyols include mannitol, isomalt, sorbitol, maltitol, xylitol, a hydrogenated starch hydrolysate/polyglycitol, and combinations thereof. The polyol or combination of polyols are present in an amount of about 80 to about 99.9 wt. % based on the total weight of the hard candy product unit, specifically about 92 to about 99 wt. %, and yet more specifically about 94 to about 99 wt. %.

The polyol or combination of polyols having low hygroscopicity and low equilibrium relative humidity used in the unwrapped hard candy product can be substantially to completely all isomalt.

The hard candy product may be free of ethanol, propylene glycol, and optionally further free of glycerol; or substantially-free of ethanol, propylene glycol, or both ethanol and propylene glycol, and optionally further substantially free of glycerol.

The hard candy product may comprise, consist of, or consists essentially of, isomalt, a flavorant, MCT oil, a colorant and a low amount of water.

The hard candy product may include water in an amount of less than or equal to 4 wt. % based on the total weight of the hard candy product, specifically 0.1 to 3 wt. %, more specifically 0.5 to 2 wt. %, and yet more specifically 1 to 1.5 wt. %.

Disclosed herein are isomalt hard candy confectioneries free of ethanol, propylene glycol, and optionally further free of glycerol; or substantially-free of ethanol, propylene glycol, or both ethanol and propylene glycol, and optionally further substantially free of glycerol. Proplyene glycol (propane-1,2-diol), ethanol, and glycerol are common flavor carriers, often used in non-citrus, fruit flavors and in mint flavors. Surprisingly, it has been found that proplyene glycol, ethanol, and glycerol, particularly propylene glycol and ethanol, react with isomalt hard candy, leading to the formation of white spots on the candy surface due to graining. It has further been found that isomalt hard candies free or substantially-free of these alcohols exhibit improved shelf life as whitening, graining, and crystallization of the isomalt hard candy are reduced. Thus, to reduce the formation of white spots and loss of translucency, and to improve the shelf life of an isomalt hard candy product, flavors free or substantially free of these alcohols, specifically ethanol and propylene glycol, are desirably used.

In general, the isomalt hard candy composition and product having improved shelf life comprises, consists, or consists essentially of, isomalt, an optional additional bulk sweetener, a flavorant, an optional additional ingredient, and a low amount of water, wherein the composition or product is free of ethanol and propylene glycol or substantially-free of ethanol, propylene glycol, or both ethanol and propylene glycol. As used herein, the term “free of ethanol and propylene glycol” means there is no amount of ethanol and no amount of propylene glycol present in the isomalt hard candy composition and product. As used herein, the term “substantially free of ethanol, propylene glycol, or both ethanol and propylene glycol” means there may be a minimal amount of ethanol, propylene glycol, or ethanol and propylene glycol present in the isomalt hard candy composition and product, the presence of which does not cause undue whitening or loss of product shelf life. The isomalt hard candy composition and product may contain 0 to 0.05 weight percent (wt. %) total ethanol and propylene glycol, specifically 0 to 0.025 wt. %, more specifically 0 to 0.01 wt. %, and still more specifically, 0 to 0.001 wt. % total ethanol and propylene glycol.

In another embodiment, the isomalt hard candy composition and product having improved shelf life comprises, consists, or consists essentially of, isomalt, an optional additional bulk sweetener, a flavorant, an optional additional ingredient, and a low amount of water, wherein the composition or product is free of ethanol and propylene glycol or substantially-free of ethanol, propylene glycol, or both ethanol and propylene glycol and further free of glycerol or substantially free of glycerol. As used herein, the term “free of glycerol” means there is no amount of glycerol present in the isomalt hard candy composition and product. As used herein, the term “substantially free of glycerol” means there may be a minimal amount of glycerol present in the isomalt hard candy composition and product, the presence of which does not cause undue whitening or loss of product shelf life. The isomalt hard candy composition and product may contain 0 to 0.05 wt. glycerol, specifically 0 to 0.025 wt. %, more specifically 0 to 0.01 wt. %, and still more specifically, 0 to 0.001 wt. % glycerol.

In another embodiment, the isomalt hard candy composition and product having improved shelf life comprises, consists, or consists essentially of, isomalt, an optional additional bulk sweetener, a flavorant, an optional additional ingredient, and a low amount of water, wherein the composition or product is free of linear and branched chain C₁-C₅ alkyl alcohol (mono-, di-, and triol) or substantially free of linear and branched chain C₁-C₅ alkyl alcohol (mono-, di-, and triol). As used herein, the term “free of linear and branched chain C₁-C₅ alkyl alcohol (mono-, di-, and triol)” means there is no amount of linear and branched chain C₁-C₅ alkyl alcohol (mono-, di-, and triol) present in the isomalt hard candy composition and product. As used herein, the term “substantially free of linear and branched chain C₁-C₅ alkyl alcohol (mono-, di-, and triol)” means there may be a minimal amount of linear and branched chain C₁-C₅ alkyl alcohol (mono-, di-, and triol) present in the isomalt hard candy composition and product, the presence of which does not cause undue whitening or loss of product shelf life. The isomalt hard candy composition and product may contain 0 to 0.05 wt. linear and branched chain C₁-C₅ alkyl alcohol (mono-, di-, and triol), specifically 0 to 0.025 wt. %, more specifically 0 to 0.01 wt. %, and still more specifically, 0 to 0.001 wt. % linear and branched chain C₁-C₅ alkyl alcohol (mono-, di-, and triol).

The isomalt hard candy product has an amorphous (glassy) form generally having water in an amount of less than or equal to 4 wt. % based on the total weight of the isomalt hard candy product, specifically about 0.1 to about 3 wt. %, more specifically about 0.5 to about 2 wt. %, and yet more specifically about 1 to about 1.5 wt. %.

The bulk sweetener used in the isomalt hard candy composition and product can be substantially to completely all isomalt. Alternatively, small amounts of a different bulk sweetener may be combined with the isomalt. In an embodiment, the bulk sweetener is about 50 to about 100 wt. % isomalt based on the total weight of the bulk sweetener components, specifically about 60 to about 100 wt. % isomalt, more specifically about 70 to about 100 wt. % isomalt, yet more specifically about 80 to about 100 wt. % isomalt, and still yet more specifically about 90 to about 100 wt. % isomalt based on the total weight of the bulk sweetener components, with the remaining balance being another bulk sweetener, such as sugar or a sugar polyol (alternatively referred to as sugar alcohol) that is not isomalt.

Isomalt is a disaccharide alcohol, which can be prepared by hydrogenating isomaltulose. Products of the hydrogenation can include 6-O-α-D-glucopyranosyl-D-sorbitol (1,6-GPS); 1-O-α-D-glucopyranosyl-D-sorbitol (1,1-GPS); 1-O-α-D-glucopyranosyl-D-mannitol (1,1-GPM); 6-O-α-D-glucopyranosyl-D-mannitol (1,6-GPM); and mixtures thereof. Some commercially available isomalt materials include an almost equimolar mixture of 1,6-GPS, and 1,1-GPM. Other isomalt materials can include predominantly or pure 1,6-GPS; predominantly or pure 1,1-GPS; predominantly or pure 1,6-GP; or predominantly or pure 1,1-GPM. Still other isomalt materials can include mixtures of two or more of 1,6-GPS; 1,1-GPS; 1,6-GPM; and 1,1-GPM at any molar ratio.

Exemplary commercially available isomalt includes Isomalt ST, including Isomalt ST-M and Isomalt ST-PF, Isomalt GS, Isomalt M, Isomalt DC, and Isomalt LM available from BENEO-Palatinit, Südzucker Group. Isomalt ST has an almost equimolar mixture of 1,6-GPS (43-57%) and 1,1-GPM. Isomalt GS contains 1,6-GPS (75-80%) and 1,1-GPM.

Isomalt is a translucent sugar alcohol that can be prepared into translucent hard candy.

Isomalt has low hygroscopicity leading to products with longer shelf life and reduced stickiness. Isomalt is resistant to acid and enzymatic hydrolysis. Complete hydrolysis of isomalt with an equimolar mixture of 1,6-GPS, and 1,1-GPM yields glucose (50%), sorbitol (25%), and mannitol (25%).

Exemplary sugar polyols that may be used in combination with isomalt to prepare the hard candy confectionery base include, for example, a hydrogenated starch hydrolysate/polyglycitol, maltitol, maltitol syrup, sorbitol syrup, and the like, or a combination thereof.

The isomalt hard candy composition and product can comprise the bulk sweetener, comprising isomalt, in an amount of about 90 to about 100 wt. % based on the total weight of the isomalt hard candy composition or product, specifically about 92 to about 98 wt. %, and yet more specifically about 94 to about 96 wt. %.

Flavorants (flavor, flavoring agent) used in confectionery and other foodstuff are often a blend of flavor materials (natural, synthetic, or a combination thereof) and a flavor solvent, alternatively called a flavor diluent or flavor carrier. Flavor carriers include propylene glycol (propane-1,2-diol, CAS No. 57-55-6, FEMA No. 2940) and its derivatives (e.g. 1,3-propane diol, CAS No. 504-63-2, FEMA No. 4753), ethanol (ethyl alcohol, CAS No. 64-17-5, FEMA No. 2419), glycerin (CAS No. 56-81-5, FEMA No. 2525, e.g. vegetable glycerin), and triacetin (CAS No. 102-76-1, FEMA No. 2007); triethyl citrate (CAS No. 77-93-0; FEMA No. 3083), Medium Chain Triglycerides (MCT; CAS No. 65381-09-1/73398-61-5; Decanoic acid, ester with 1,2,3-propanetriol octanoate; Octanoic/Decanoic Acid Triglyceride; Caprylic Capric Triglyceride, Caprylic/Capric Triglyceride; Triglyceride of Coconut Oil); a combination thereof, and the like.

Flavorants, particularly non-citrus fruit flavors such as berry (strawberry, raspberry, blackberry, cherry, and the like), contain substantial quantities of ethanol, propylene glycol, or a combination thereof as flavor carriers. In a method to reduce graining and premature aging in isomalt hard confectionery, specifically those comprising a non-citrus fruit flavorant or mint flavorant, the flavorant is formulated to be free of ethanol and propylene glycol, or substantially free of, ethanol, propylene glycol, or both ethanol and propylene glycol.

In an embodiment, a flavorant used in the hard confectionery composition and product is free of ethanol and propylene glycol, or substantially free of, ethanol, propylene glycol, or both ethanol and propylene glycol as a flavor carrier, thus preventing whitening in the hard confectionery product and extending the product's shelf life, specifically in an isomalt hard confectionery composition and product. In another embodiment, the flavorant is further free of glycerol or substantially free of glycerol. In a further embodiment, the flavorant is a non-citrus, fruit flavorant. In another further embodiment, the flavorant is a mint flavorant.

In an embodiment, each flavorant used in the hard candy composition and product, specifically an isomalt hard candy composition and product, is free of ethanol and propylene glycol, or substantially free of, ethanol, propylene glycol, or both ethanol and propylene glycol. As used herein, with respect to the flavorant, the term “free of ethanol and propylene glycol” means there is no amount of ethanol and no amount of propylene glycol present in the flavorant. As used herein, with respect to the flavorant, the term “substantially free of, ethanol, propylene glycol, or both ethanol and propylene glycol” means there may be a minimal amount of ethanol, propylene glycol, or ethanol and propylene glycol present in the flavorant, such as those amounts inherently present in a natural flavorant. The flavorant may contain 0 to 10 wt. % total ethanol and propylene glycol, specifically 0 to 5 wt. %, more specifically 0 to 1 wt. %, and still more specifically, 0 to 0.1 wt. % total ethanol and propylene glycol.

In another embodiment, each flavorant is free of linear and branched chain C₁-C₅ alkyl alcohol (mono-, di-, and triol) or substantially free of linear and branched chain C₁-C₅ alkyl alcohol (mono-, di-, and triol). The flavorant may contain 0 to 10 wt. % linear and branched chain C₁-C₅ alkyl alcohol (mono-, di-, and triol), specifically 0 to 5 wt. %, more specifically 0 to 1 wt. %, and still more specifically, 0 to 0.1 wt. % total linear and branched chain C₁-C₅ alkyl alcohol (mono-, di-, and triol).

In an embodiment, the flavor carriers that are linear and branched chain C₁-C₅ alkyl alcohol (mono-, di-, and triol), e.g., ethanol, propylene glycol, and glycerol, present in a flavorant are replaced with a flavor carrier that does not adversely affect the stability of the isomalt hard candy, i.e., triacetin, MCT oil, or a combination thereof. Replacing linear and branched chain C₁-C₅ alkyl alcohols (mono-, di-, triol) such as ethanol, propylene glycol, and glycerol, in the flavorant to be used in an isomalt hard candy product will mitigate premature graining. Exemplary flavorants (flavor, flavoring agent) that can be used include artificial or natural flavors, for example synthetic flavor oils, natural flavoring aromatics and/or oils, oleoresins, extracts derived from plants, leaves, flowers, fruits, and the like, or a combination thereof. Non-limiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences/flavors, including apple, pear, peach, grape, strawberry, raspberry, blackberry, cherry, plum, pineapple, apricot, banana, melon, tropical fruit, mango, mangosteen, pomegranate, papaya, honey lemon, and the like, or a combination thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin).

The amount of flavorant used in the hard candy composition and product can be chosen based on the targeted release profile and flavor intensity desired. The flavorant can be present in the hard candy product in an amount of about 0.001 to about 3 wt. % based on the total weight of the hard candy product, specifically about 0.01 to about 2 wt. %, more specifically about 0.1 to about 1.5 wt. %, and yet more specifically about 0.5 to about 1 wt. %.

Optional additional ingredients used to prepare isomalt hard candy composition and product caninclude MCT oil, a colorant, a sensate, a food acid or salt thereof, a high intensity sweetener, a buffering agent, a functional agent, or a combination thereof as described herein.

MCT oil can be included in the isomalt hard candy composition and product in a stabilizing amount to inhibit premature graining and minimize sticking. Exemplary amounts of MCT oil can be about 0.01 to about 1.0 wt. % based on the total weight of the composition or product, specifically about 0.05 to about 0.9 wt. %, more specifically about 0.1 to about 0.7 wt. %, and yet more specifically about 0.15 to about 0.6 wt. %.

Exemplary sensates include cooling agents, warming agents, tingling agents, effervescent agents, or a combination thereof. Cooling agents are additives that provide a cooling or refreshing effect in the mouth, in the nasal cavity, or on skin. For example, among the useful cooling agents are included menthol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-2,2-diisopropylbutanamide, N-ethyl-p-menthane-3-carboxamide (WS-3), ethyl ester of N-[[5-methyl-2-(1-methylethyl)cyclohexyl]carbonyl]glycine (WS-5), as well as the substantially pure ethyl ester of N-[[5-methyl-2-(1-methylethyl)cyclohexyl]carbonyl]glycine as disclosed in U.S. Pat. No. 7,189,760 to Erman, et al which is incorporated in its entirety herein by reference, isopulegol, menthyloxy propane diol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, N-(4-cyanomethylphenyl) p-menthanecarboxamide (G-180), Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; Menthol methyl ether, menthyl pyrrolidone carboxylate; 2,5-dimethyl-4-(1-pyrrolidinyl)-3(2H)-furanone; cyclic α-keto enamines, cyclotene derivatives such as cyclopentenes including 3-methyl-2-(1-pyrrolidinyl)-2-cyclopenten-1-one and 5-methyl-2-(1-pyrrolidinyl)-2-cyclopenten-1-one, compounds of the formula:

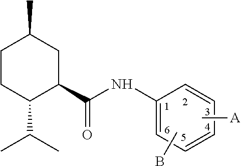

wherein B is selected from H, CH₃, C₂H₅, OCH₃, OC₂H₅; and OH; and wherein A is a moiety of the formula-CO-D, wherein D is selected from the following moieties: (i)-NR¹R², wherein R¹ and R² are independently selected from H and C₁-C₈ straight or branched-chain aliphatic, alkoxyalkyl, hydroxyalkyl, araliphatic and cycloalkyl groups, or R¹ and R² together with the nitrogen atom to which they are attached form part of an optionally-substituted, five-or six-membered heterocyclic ring; (ii)-NHCH₂COOCH₂CH₃,—NHCH₂CONH₂,—NHCH₂CH₂OCH₃,—NHCH₂CH₂OH,—NHCH₂CH(OH)CH₂OH and (iii) a moiety selected from the group consisting of:

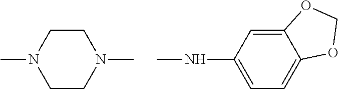

as disclosed in PCT Patent Application WO2006/125334 to Bell et al. which is incorporated in its entirety herein by reference, among others; or a combination thereof. Other compounds include the alpha-keto enamines disclosed in U.S. Pat. No. 6,592,884 to Hofmann et al. which is incorporated in its entirety herein by reference. These and other suitable cooling agents are further described in the following U.S. patents, all of which are incorporated in their entirety by reference hereto: U.S. Pat. Nos. 4,230,688; 4,032,661; 4,459,425; 4,178,459; 4,296,255; 4,136,163; 5,009,893; 5,266,592; 5,698,181; 6,277,385; 6,627,233; 7,030,273. Still other suitable cooling agents are further described in the following U.S. Published Patent Applications, all of which are incorporated in their entirety by reference hereto: U.S. 2005/0222256; 2005/0265930.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming agents included are vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, or a combination thereof.

In an embodiment, tingling agents may be employed to provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; perillartine; 4-(1-menthoxymethyl)-2-phenyl-1,3-dioxolane; black pepper extract (Piper nigrum), including the active ingredients chavicine and piperine; Echinacea extract; Northern Prickly Ash extract; trans-pellitorin, and red pepper oleoresin; szechuan peppercorn; or a combination thereof. In an embodiment, alkylamides extracted from materials such as jambu or sanshool may be included.

The sensate, specifically the cooling agent, can be present in the hard candy composition or product in an amount of about 0.001 to about 1 wt. % based on the total weight of the hard candy composition or product, specifically about 0.01 to about 0.7 wt. %, and yet more specifically about 0.1 to about 0.5 wt. %.

A “high intensity sweetener” as used herein means agents having a sweetness greater than the sweetness of sucrose. In an embodiment, a high intensity sweetener has a sweetness that is at least 100 times that of sugar (sucrose) on a per weight basis, specifically at least 500 times that of sugar on a per weight basis. In an embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used. Without being limited to particular sweeteners, representative categories and examples include: water-soluble sweetening agents such as dihydrochalcones, monellin, steviosides, rebaudiosides, glycyrrhizin, dihydroflavenol, monatin, and L-aminodicarboxylic acid aminoalkenoic acid ester amides, such as those disclosed in U.S. Pat. No. 4,619,834, or a combination thereof; water-soluble artificial sweeteners such as soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination thereof; dipeptide based sweeteners, for example the L-aspartic acid derived sweeteners such as L-aspartyl-L-phenylalanine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, neotame, or a combination thereof; water-soluble sweeteners derived from naturally occurring water-soluble sweeteners, such as steviosides and stevia derived compounds such as but not limited to steviol glycosides such as rebaudiocides including rebaudiocide A, and the like, lo han quo and lo han quo derived compounds such as iso-mogroside V and the like, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-l-deoxy-beta-D-fructo-furanoside, or 4,1′-dichloro-4,1′-dideoxygalactosucrose; 1′,6′-dichlorol′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; 4,6,1′,6′-tetradeoxy-sucrose, or a combination thereof; protein based sweeteners such as thaumaoccous danielli, talin, or a combination thereof; and amino acid based sweeteners.

The high intensity sweetener can be present in the hard candy composition or product in an amount of about 0.001 to about 1 wt. % based on the total weight of the hard candy composition or product, specifically about 0.01 to about 0.7 wt. %, and yet more specifically about 0.1 to about 0.5 wt. %.

The food acid can be in free or buffered form. Exemplary food acids and food acid salts include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and alkali metal salts thereof (e.g., sodium citrate dihydrate), or a combination thereof.

The food acid can be present in the hard candy composition or product in an amount of about 0.001 to about 1.5 wt. % based on the total weight of the hard candy composition or product, specifically about 0.01 to about 1 wt. %, and yet more specifically about 0.1 to about 0.8 wt. %.

Coloring agents (colors, colorants, colorings) can be used in amounts effective to produce a desired color for the composition which can be perceived visually. Suitable coloring agents include pigments, natural food colors and dyes suitable for food, drug, and cosmetic applications. Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-β′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), or a combination thereof. In an embodiment, certified colors can include FD&C aluminum lakes, or a combination thereof. A full recitation of all FD& C colorants and their corresponding chemical structures may be found in the Kirk-Othmer Encyclopedia of Chemical Technology, 4th Edition, in volume 1 at pages 492-494, which text is incorporated herein by reference.

Coloring agents can also include food grade glitter or food grade pearlescent pigments. The edible glitter can include a food grade colorant and a carrier such as a sugar, a sugar alcohol, a saccharide, a disaccharide, a polysaccharide, a hydrocolloid material, or a combination thereof. Exemplary glitter includes the commercially available Edible Glitter™ from Watson Inc. of West Haven, CT. The coloring agent can include food grade pearlescent pigments prepared from mica optionally coated with titanium dioxide, iron oxide, and the like.

Exemplary functional ingredients include a breath freshener, a dental care component, an active, an herbal, an effervescing system, an appetite suppressor, a vitamin, a micronutrient, a mouth moistening component, a throat care component, an energy boosting agent, a concentration boosting agent, or a combination thereof.

In an embodiment, a packaged plurality of unwrapped hard candy product comprises a resealable container; and a plurality of unwrapped hard candy product units housed within the resealable container, the hard candy product comprises, consists of, or consists essentially of, isomalt, flavorant, MCT oil, and a moisture content of less than or equal to 4 wt. %, specifically less than or equal to 3 wt. %; and wherein each unit of hard candy product has a weight of less than or equal to 1 gram, specifically about 0.2 to about 0.8 gram, and more specifically about 0.5 to about 0.7 gram. In an embodiment, the resealable container itself is packaged within a moisture barrier material. As used herein, the term “plurality” means at least 5 units, at least 10 units, at least 15 units, at least 20 units, at least 25 units, at least 30 units, at least 40 units, at least 50 units, at least 75 units, at least 100 units, or more or any range therein, e.g. 10 to 30. The packaged plurality includes the hard candy product units having a spherical shape or oblong shape, specifically a spherical shape. The hard candy product units may also have a band around the candy which may contain a letter or other indicia. The hard candy product is formed by rope forming and die forming processes as described herein and conditioned after piece formation. The presence of the hydrophobic lubricant and microcrystalline layer in the hard candy product minimizes or prevents the hard candy product units from adhering to one another in the container and to allow the units to freely pour from the container. In an embodiment, a packaged plurality of unwrapped small hard candy product prepared from isomalt and MCT oil, wherein the presence of the MCT oil minimizes or inhibits graining, color fade, change of surface appearance, or a combination thereof of the hard candy product from time zero to 5 weeks of controlled accelerated aging at conditions of 37° C.+/−2° C. and 80%+/−5% relative humidity (RH) when the plurality is housed in a container comprising a moisture barrier material or a container packaged within a moisture barrier material. In an embodiment, a packaged plurality of unwrapped small hard candy product prepared from isomalt and MCT oil, wherein the hard candy product comprising MCT oil exhibits better surface appearance, reduced graining, reduced color fade, or a combination thereof from time zero to 5 weeks of controlled accelerated aging at conditions of 37° C.+/−2° C. and 80%+/−5% relative humidity (RH) when the plurality is housed in a container comprising a moisture barrier material or a container packaged within a moisture barrier material compared to hard candy free of MCT oil.

Disclosed herein is a method of preparing a hard candy product having a mass less than or equal to 1 gram, specifically about 0.4 to about 0.8 gram. The method includes forming a cooked mass comprising the polyol with low hygroscopicity and hydrophobic lubricant. The cooked mass has a moisture content less than or equal to 4 wt. % , specifically less than or equal to 3 wt. % based on the total weight of the cooked mass. The cooked mass is cooled and a flavorant is added to form a melt. The melt is formed into a hard candy product having a weight of less than or equal to 1 gram. It is believed that the hydrophobic lubricant is present at the surface of the hard candy product and its hydrophobic nature retards moisture from contacting the surface and creating large crystals or whitening. Additionally, the presence of the hydrophobic lubricant may lubricate the candy melt and reduce the shear stress during processing thus reducing shear induced crystallization.

In general, preparation of the hard candy product includes cooking a combination of polyol with low hygroscopicity, hydrophobic lubricant, and optionally, other bulk sweetener components and/or a diluent such as water and removing excess moisture to form a cooked mass having a moisture content less than or equal to 4 wt. %, specifically less than or equal to 3 wt. % based on the total weight of the cooked mass; cooling the cooked mass; incorporating a flavorant and any remaining optional additional ingredients with mixing to form a melt; and forming the melt into a solid product having the desired size and shape.

In general, preparation of the isomalt hard boiled candy includes forming a melt of isomalt and optionally, other bulk sweetener components and/or a diluent such as water; cooking the melt; removing excess moisture from the melt, for example reducing the moisture content to less than or equal to 4 wt. %, specifically less than or equal to 3 wt. % based on the total weight of the melt; cooling the melt through mixing until the melt is a workable mass having a plastic-like consistency; while the melt is a plastic-like mass, incorporating a flavorant and any remaining optional additional ingredients with mixing; and forming the plastic-like mixture into a solid product having the desired size and shape.

In an alternate embodiment, preparation of the isomalt hard boiled candy includes forming a melt of isomalt and optionally, other bulk sweetener components, without the use of a diluent such as water; cooking the melt; cooling the melt through mixing until the melt is a workable mass having a plastic-like consistency; while the melt is a plastic-like mass, incorporating a flavorant and any remaining optional additional ingredients with mixing; and forming the plastic-like mixture into a solid product having the desired size and shape

In one embodiment, the hard candy product composition is generally prepared by cooking a mixture of polyol, hydrophobic lubricant, and water, or polyol, hydrophobic lubricant, additional sugar polyol, and water at 155° C., optionally under vacuum, to achieve a cooked mass having a moisture content less than or equal to 4 wt. %, specifically less than or equal to 3 wt. % based on the total weight of the cooked mass. The cooked mass is cooled slightly and a flavorant and any optional additive such as a food acid, a high intensity sweetener, a sensate, an additional ingredient, or a combination thereof, is added to the cooked mass to form a melt, the melt is then formed in a molding or piece forming process to form the hard candy product. The moisture content of the hard boiled candy melt can be about 0.1 to about 4 wt. % based on the total weight of the hard boiled candy melt, specifically about 0.2 to about 3 wt. %, more specifically about 0.5 to about 2 wt. %, and yet more specifically about 1 to about 1.5 wt. %.

In one embodiment, the isomalt hard candy composition is generally prepared by cooking a mixture of isomalt, or isomalt and additional sugar polyol, and water at about 155° C., optionally under vacuum to achieve a moisture content at or below 4 wt. %, specifically at or below 3wt. % based on the total weight of the cooked mixture. The cooked mixture is cooled slightly and a flavorant and any optional additive such as a food acid, a high intensity sweetener, a sensate, an additional ingredient, or a combination thereof, is added to the cooled mixture to form a confectionery melt, the melt is then formed in a molding or piece forming process to form the isomalt hard candy product. The moisture content of the isomalt hard boiled candy melt can be about 0.1 to about 4 wt. % based on the total weight of the isomalt hard boiled candy melt, specifically about 0.2 to about 3 wt. %, more specifically about 0.5 to about 2 wt. %, and yet more specifically about 1 to about 1.5 wt. %.

In some embodiments, the hard candy compositions are prepared using conventional methods and equipment, such as fire cookers, vacuum cookers, or scraped-surface cookers (also referred to as high speed atmospheric cookers). When using a fire cooker, the desired quantity of bulk sweetener (e.g., isomalt) is dissolved in water by heating in a kettle until the bulk sweetener dissolves. Additional bulk sweetener can then be added and the cooking continued until a final temperature of, for example, about 145 to about 165° C. is achieved. The batch is then cooled and worked as a plastic-like mass to incorporate additives separately or in the form of a concentrate.

In vacuum cookers, a bulk sweetener is boiled to about 125 to about 132° C., a vacuum is applied, and additional water is boiled off without extra heating. When cooking is complete, the cooked mass is a semi-solid and has a plastic-like consistency. At this point, additives, separately or in the form of a concentrate are admixed in the cooked mass by mechanical mixing operations.

A high-speed atmospheric cooker uses a heat exchanger surface to heat the confectionery composition. In this process, a film of combined components is spread onto the heat exchange surface, and is rapidly heated to a suitable temperature, for example about 165 to about 170° C. The film is then rapidly cooled, for example to about 100 to about 120° C. Additives, either separately or in the form of a concentrate, can then be incorporated into the plastic-like cooked mass.

In the foregoing methods, the cooking temperature should be sufficiently high to drive water from the mix. Where a vacuum is employed, lower temperatures can typically be used. In the foregoing methods, the additive(s) are specifically mixed for a time effective to provide a uniform distribution of the additive materials, for example about 4 to about 10 minutes. Once the cooked mass has been properly tempered, it can be cut into workable portions or formed into desired shapes using molding or piece forming processes.

Suitable molding and piece forming processes can include a depositing process including a deposit molding process, a rotary molding process, a die-stamping process, drop roller process, chain-die process, and the like.

The temperature of the hard candy melt during depositing in a deposit molding process can be about 125 to about 155° C., specifically about 140° C. The deposited product is then cooled and de-molded.

Suitable piece forming processes for the small hard candy product include die forming including chain-die, rotary die, die-stamping, drop roller, or other similar process.

In an embodiment, the small hard candy product cooked mass can be prepared by a batch or a continuous process, formed into an initial rope in a batch roller or by extrusion from an extruder, the initial rope is sized in a rope sizer to a final rope having a desired diameter, and forming the final rope into pieces using a die forming process such as a chain-die or rotary die process.

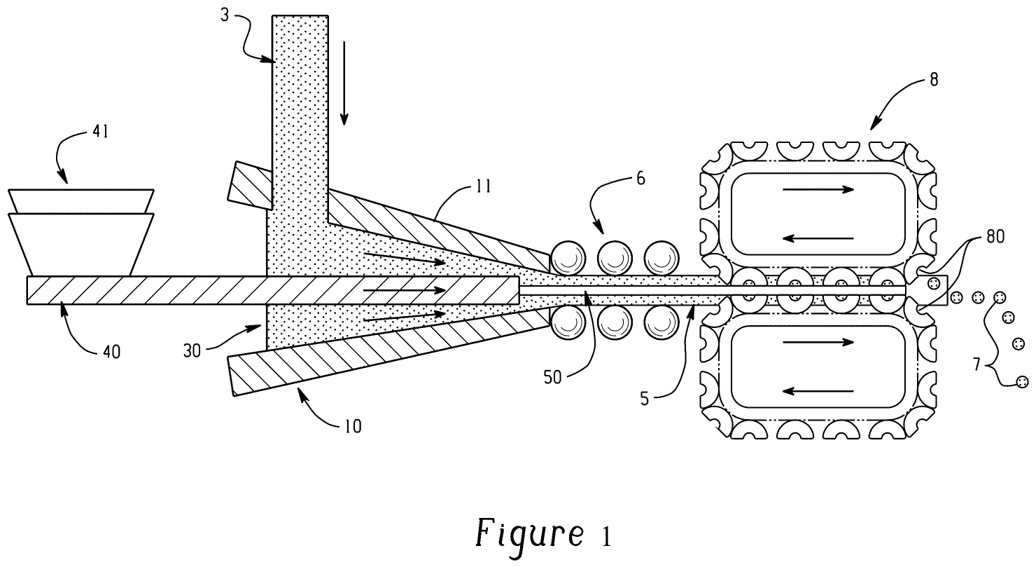

As shown in FIG. 1, the melt 3 is conveyed to a batch roller 10 in which a cone 30 of the melt is pulled out. The batch roller includes a number of conical rollers 11 which have the function of forming a continuous rope of melt at the end. An optional center component 40 may be positioned in the cone 30 and a center filling may be placed in the rope. The next stage sizes the rope 5 to the desired cross-section by using a rope sizer 6. The rope sizer 6 uses one or more series of rollers to decrease the diameter and circumference of the rope to the desired size. Individual hard candy products 7 are cut (segmented) and shaped from the rope in a die-forming device 8 such as a chain die like assembly. The chain die assembly 8 comprises pairs of half-die members 80 that assemble during rotation of the chains and punch the rope into the individual desired shapes.

After piece formation, the newly formed small hard candy products can be conditioned to allow for microcrystallization at the surface of the product. Microcrystallization is a crystallization of the crystallizable sugar polyol(s) on or near the surface of the hard candy product and is invisible or nearly invisible to the naked eye and does not render the hard candy product white and opaque. In an embodiment, the newly formed products are conditioned at a relative humidity which is the equilibrium relative humidity of the polyol+/−20%, or the equilibrium relative humidity of the polyol+/−10%, and 18 to 28° C., specifically 20 to 25° C. for up to 4 days, specifically 24 to 72 hours. For example, if the equilibrium relative humidity of the polyol is 40% then conditioning may be conducted at a relative humidity of 20% to 60% (40%+/−20%) or at a relative humidity of 30% to 50% (40%+/−-10%). When multiple polyols are used the conditioning relative humidity is based on the equilibrium relative humidity of the polyol present in a majority amount.

The piece shape of the small hard candy products is not limited and include general shapes such as sphere, oblong, capsule shaped, cuboid, cylinder, prism, fruit, and the like. In an embodiment, the small hard candy product is spherical shape or oblong shape, specifically spherical. As used herein, when describing the shape of a product, unless otherwise specified, it is understood that the characterization is for the overall shape, for example a “spherical shape” is one where the overall shape of the product is a sphere even if the surface of the product may not completely smooth, e.g., having the presence of a belly band, dimples, indentations, protrusions, etc.

The process of preparation can be adapted by those skilled in the art to provide a hard candy product having a desired configuration, including single-layer, multi-layer having two or more layers (for example, three layers), and forms having a center-fill.

In one embodiment, the hard candy product is an unfilled, solid product.

In an embodiment, the hard candy product can be a center-filled product. Within this embodiment, the center-fill can be a liquid, solid, or semi-solid. The center-fill can be another hard boiled candy, a water-in-oil emulsion, an oil-in-water emulsion, a gel, a powder, a chewy confectionery, a fudge, a nougat, a chewing gum, and the like. Further within this embodiment, the center-fill composition can be substantially free or free of ethanol, propylene glycol, or both ethanol and propylene glycol.

The hard candy product can be individually wrapped and packaged. Alternatively, a plurality of hard candy products can be packaged as unwrapped, loose units in a container. In a further embodiment, the container housing the unwrapped, loose units of hard candy product is itself contained within a package. Exemplary packaging includes bags, cartons, boxes, blister pack, cylindrical containers, etc. made of suitable food-safe packaging material, for example paper, plastic, and the like or a combination thereof such as laminated paperboard. In an embodiment, the package comprises a moisture barrier or has a moisture barrier overwrap. In an embodiment, the plurality of hard candy products can be packaged as unwrapped, loose units in a container and the container is packaged in a material that provides a moisture barrier. Suitable moisture barrier materials include high density polyethylene, polypropylene, polyethylene terephthalate, ethylene vinyl alcohol copolymer, and the like.

The features and advantages are more fully shown by the following examples which are provided for purposes of illustration and are not to be construed as limiting the invention in any way.

### EXAMPLES

### Example 1. Drip Test for Product Stability: Isomalt Hard Candy Sheets Exposed to Flavor Carriers

An isomalt standard base composition and an isomalt medium chain triglyceride (MCT) oil composition were each prepared and formed into sheets of clear isomalt hard candy for use as substrates in a stability test. The test was conducted to examine the effect of various flavor carriers applied to the surface of the sheets prepared from isomalt hard candy. Five test flavor carriers were studied: glycerol (glycerine or glycerin), ethanol, triacetin (glyceryl triacetate), propylene glycol, and MCT oil.

The isomalt standard base composition was prepared from isomalt : water (70:30) and cooked to 172° C. to form a base melt. The base melt was poured onto a tempering table and cooled to form a sheet of isomalt standard base. The isomalt MCT oil composition was prepared from isomalt : water (70:30) and MCT oil at 0.6 wt. % and cooked to 172° C. to form an isomalt MCT oil melt. The isomalt MCT melt was poured onto a tempering table and cooled to form a sheet of isomalt MCT oil composition. The isomalt used in each composition was Isomalt ST containing roughly equimolar quantities of 1,6-GPS, and 1,1-GPM.

Using a marker to draw on the surface of the sample sheet, each sample sheet was divided into zones of substantially the same surface area. Individual zones were labeled with a name of one of the test flavor carriers: glycerol (glycerine or glycerin), ethanol, triacetin (glyceryl triacetate), propylene glycol, or MCT oil: A quantity of about 1-3 drops of each test flavor carrier was dropped onto their respective zones of the sample sheet. Changes to the surface of the sample sheets were observed visually at time zero (after initial exposure to the carrier), and over time up to 1 hour. After the surface of the sheet was observed for time zero, the sample sheets were placed in 25° C/60% relative humidity (RH) conditions to accelerate aging.

Isomalt Standard Base Sheet—Observations: The surface of the Isomalt Standard Base sheet turned white in the zones that were individually surface treated with propylene glycol and ethanol. Ethanol instantly turned the surface white. The region exposed to propylene glycol turned progressively whiter over time within the first day. The glycerol treated zone turned white after aging between 1 and 7 days. No changes to the surface were observed in the MCT oil and triacetin treated zones at the end of 7 days.

Isomalt MCT Oil Sheet—Observations: The surface of the Isomalt MCT Oil sheet turned white in the zones that were individually surface treated with propylene glycol and ethanol. Ethanol instantly turned the surface white (less than 2 minutes). The region exposed to propylene glycol turned progressively whiter over time increasing in opacity at 20 minutes and again at up to one hour after treatment. The glycerol treated zone turned white after aging between 1 and 7 days. No changes to the surface were observed in the MCT oil and triacetin treated zones at the end of 7 days.

The results of the Drip Test for stability suggests that flavorants containing ethanol, propylene glycol, or both should be minimized or avoided in an isomalt hard candy composition and product in order to enhance the product's stability and shelf life, minimize or avoid product whitening and minimize or avoid loss of product translucency.

### Example 2

An isomalt standard base composition and an isomalt medium chain triglyceride (MCT) oil composition were each prepared. The isomalt standard base composition was prepared from isomalt : water (70:30) and cooked to 172° C. to form a cooked mass. The isomalt MCT oil composition was prepared from isomalt:water (70:30) and MCT oil at 0.6 wt. % and cooked to 172° C. to form an isomalt MCT oil cooked mass. The isomalt used in each composition was Isomalt ST containing roughly equimolar quantities of 1,6-GPS, and 1,1-GPM.

Example: Fruit flavored and Menthol flavored isomalt formulations were separately prepared and formed into small hard candy products of a generally spherical shape and 0.6 grams per piece using a rope forming and die punching process. The process exposed the product to high shear compared to products of larger size. Formulations with and without MCT oil were prepared for each flavor. The moisture content of the pieces was no greater than 2%. Table 1 reports six products, two Fruit and four Menthol. The table also indicates which samples were conditioned after piece formation at 36-40% RH and 20-25° C. for 30-72 hours.

TABLE 1

| Formulation # | Ingredients |
|---|---|
| 1 Fruit, | Isomalt, fruit flavor, color, high intensity sweetener |
| no MCT oil, | |
| conditioned | |
| 2 Fruit, | Isomalt, fruit flavor, color, high intensity sweetener, |
| MCT oil, | MCT oil (0.6 weight % based on total weight of product) |
| conditioned | |
| 3 Menthol, | Isomalt, methol, color, high intensity sweetener |
| no MCT oil, | |
| unconditioned | |
| 4 Menthol, | Isomalt, methol, color, high intensity sweetener |
| no MCT oil, | |
| conditioned | |
| 5 Menthol, | Isomalt, menthol, color, high intensity sweetener, |
| MCT oil, | MCT oil (0.6 weight % based on total weight of product) |
| unconditioned | |
| 6 Menthol, | Isomalt, menthol, color, high intensity sweetener, |
| MCT oil, | MCT oil (0.6 weight % based on total weight of product) |
| conditioned | |

Accelerated Stability conditions: Products (˜24-25 pieces) were packaged in a plastic vial and the vial in a blister tray sealed with paperboard card (consumer unit). Five consumer units of each flavor formulation were tested under controlled accelerated aging conditions 37° C.+/−2° C. and 80%+/−5% relative humidity (RH). Study duration: 5 weeks for a Target shelf life of 20 months, approximately 80 weeks. Samples were pulled every week for total 5 weeks to conduct an organoleptic/sensory evaluation for Hand Stickiness, Deformity, Surface Appearance, Fading Color, Grain, Mouth Roughness, and Tooth Stickiness. Table 2 provides a summary of physical/organoleptic results at 5 weeks. Test samples were observed by the naked eye for visual changes from initial, unaged sample (standard): Failure=a surface appearance having visible whitening or color fade compared to standard; Passing=no visible appearance of whitening or color fade compared to standard.

TABLE 2

| Formulation | Physical/Organoleptic Summary at 5 weeks |
|---|---|
| 1 Fruit, | Failed physical attributes. |
| no MCT oil, | |
| conditioned | |
| 2 Fruit, | Best physical attributes and surface appearance compared |
| MCT oil, | to Formulation 1; MCT oil mitigated physical attributes |
| conditioned | of aging. |
| | Pieces cut in half showed that the hydrophobic properties |
| | of the MCT oil slowed down the crystallization process |
| | on the outer surface of the piece. |
| 3 Menthol, | Failed physical attributes. |
| no MCT oil, | |
| unconditioned | |
| 4 Menthol, | Failed physical attributes. |
| no MCT oil, | |
| conditioned | |
| 5 Menthol, | Initial surface appearance good, failed due to excessive |
| MCT oil, | crystallization after aging. |
| unconditioned | |
| 6 Menthol, | Passes for physical attributes; the addition of MCT oil |
| MCT oil, | and conditioning of this product resulted in better |
| conditioned | physical appearance attributes compared to product |
| | without MCT oil. |
| | Pieces cut in half showed that the hydrophobic properties |
| | of the MCT oil slowed down the crystallization process |
| | on the outer surface of the piece. |

The results of the accelerated aging study reveal the products prepared from formulations containing MCT oil showed improved physical attributes over the formulations without MCT oil, and the combination of MCT oil and conditioning provided acceptable shelf life. The surface of the products prepared from the formulations containing MCT oil exhibited less graining and a superior visual appearance.

The compositions, products, and processes disclosed herein include(s) at least the following aspects:
Aspect 1. A hard candy product, comprising: isomalt, a flavorant, and optionally an additional ingredient, wherein the hard candy product is free of ethanol and propylene glycol, or substantially free of ethanol, propylene glycol, or both ethanol and propylene glycol.
Aspect 2. The hard candy product of Aspect 1, comprising 0 to 0.05 wt. % total ethanol and propylene glycol based on the total weight of the hard candy product, specifically 0 to 0.025 wt. %, more specifically 0 to 0.01 wt. %, and still more specifically, 0 to 0.001 wt. % total ethanol and propylene glycol.
Aspect 3. The hard candy product of Aspect 1 or 2, wherein the hard candy product is further free of glycerol; or substantially free of glycerol.
Aspect 4. The hard candy product of Aspect 3, comprising 0 to 0.05 wt. % total glycerol based on the total weight of the hard candy product, specifically 0 to 0.025 wt. %, more specifically 0 to 0.01 wt. %, and still more specifically, 0 to 0.001 wt. % total glycerol.
Aspect 5. The hard candy product of any one of Aspects 1-4, wherein the hard candy product is free of linear and branched chain C₁-C₅ alkyl alcohols comprising 1, 2, or 3 hydroxy groups; or substantially free of linear and branched chain C₁-C₅ alkyl alcohols comprising 1, 2, or 3 hydroxy groups.
Aspect 6. The hard candy product of Aspect 5, comprising 0 to 0.05 wt. % total linear and branched chain C₁-C₅ alkyl alcohols based on the total weight of the hard candy product, specifically 0 to 0.025 wt. %, more specifically 0 to 0.01 wt. %, and still more specifically, 0 to 0.001 wt. % total linear and branched chain C₁-C₅ alkyl alcohols,
Aspect 7. The hard candy product of any one of Aspects 1-6, wherein the flavorant is free of ethanol and propylene glycol, or substantially free of ethanol, propylene glycol, or both ethanol and propylene glycol.
Aspect 8. The hard candy product of any one of Aspects 1-7, wherein the flavorant is free of glycerol or substantially free of glycerol.
Aspect 9. The hard candy product of any one of Aspects 1-8, wherein the flavorant is free of linear and branched chain C₁-C₅ alkyl alcohols comprising 1, 2, or 3 hydroxy groups; or substantially free of linear and branched chain C₁-C₅ alkyl alcohols comprising 1, 2, or 3 hydroxy groups.
Aspect 10. The hard candy product of any one of Aspects 1-9, wherein the flavorant is a mint flavorant or a non-citrus, fruit flavorant.
Aspect 11. The hard candy product of any one of Aspects 1-10, wherein the flavorant is a non-citrus, fruit flavorant.
Aspect 12. The hard candy product of any one of Aspects 1-11, wherein the flavorant comprises MCT oil, triacetin, or a combination thereof as a flavor carrier.
Aspect 13. The hard candy product of any one of Aspects 1-12, wherein the isomalt comprises 6-O-α-D-glucopyranosyl-D-sorbitol (1,6-GPS); 1-O-α-D-glucopyranosyl-D-sorbitol (1,1-GPS); 1-O-α-D-glucopyranosyl-D-mannitol (1,1-GPM); 6-O-α-D-glucopyranosyl-D-mannitol (1,6-GPM); or a combination thereof; or the isomalt comprises a substantially equimolar mixture of 1,6-GPS, and 1,1-GPM.
Aspect 14. The hard candy product of any one of Aspects 1-13, wherein the additional ingredient is MCT oil, a colorant, a sensate, a food acid or salt thereof, a high intensity sweetener, a buffering agent, a functional agent, or a combination thereof.
Aspect 15. The hard candy product of any one of Aspects 1-14, comprising water in an amount of less than or equal to 4 wt. % based on the total weight of the hard candy product, specifically about 0.1 to about 3 wt. %, more specifically about 0.5 to about 2 wt. %, and yet more specifically about 1 to about 1.5 wt. %.
Aspect 16. A method of preparing a hard candy product of any one of Aspects 1-15, comprising: cooking a mixture of isomalt and water, optionally under vacuum, to achieve a moisture content at or below 4 wt. %, specifically at or below 3 wt. % based on the total weight of the cooked mass, or melting isomalt to form a cooked mass; cooling the cooked mass and adding the flavorant and optional additional ingredient with mixing to form a melt; forming the melt into the hard candy product, wherein the hard candy product is free of ethanol and propylene glycol, or substantially free of ethanol, propylene glycol, or both ethanol and propylene glycol.
Aspect 17. The method of Aspect 16, wherein the hard candy product is further free of glycerol, or substantially free of glycerol; or free of linear and branched chain C₁-C₅ alkyl alcohols comprising 1, 2, or 3 hydroxy groups, or substantially free of linear and branched chain C₁-C₅ alkyl alcohols comprising 1, 2, or 3 hydroxy groups.
Aspect 18. The method of Aspect 16 or 17, wherein the flavorant is free of ethanol and propylene glycol, or substantially free of ethanol, propylene glycol, or both ethanol and propylene glycol.
Aspect 19. The method of any one of Aspects 16-18, wherein the flavorant is further free of glycerol, or substantially free of glycerol; or free of linear and branched chain C₁-C₅ alkyl alcohols comprising 1, 2, or 3 hydroxy groups, or substantially free of linear and branched chain C₁-C₅ alkyl alcohols comprising 1, 2, or 3 hydroxy groups.
Aspect 20. A method of extending the shelf life of an isomalt hard candy, comprising: using a flavorant in the isomalt hard candy composition, wherein the flavorant is free of ethanol and propylene glycol, or substantially free of ethanol, propylene glycol, or both ethanol and propylene glycol; optionally the flavorant is further free of glycerol or further substantially free of glycerol.
Aspect 21. The method of Aspect 20, wherein the flavorant is free of linear and branched chain C₁-C₅ alkyl alcohols comprising 1, 2, or 3 hydroxy groups, or substantially free of linear and branched chain C₁-C₅ alkyl alcohols comprising 1, 2, or 3 hydroxy groups.
Aspect 22. The method of Aspect 20 or 21, wherein the flavorant has MCT oil, triacetin, or a combination thereof as a flavor carrier.
Aspect 23. The method of any one of Aspects 20-22, wherein the flavorant has 0 to 10 wt. % total ethanol and propylene glycol based on the total weight of the flavorant, specifically 0 to 5 wt. %, more specifically 0 to 1 wt. %, and still more specifically, 0 to 0.1 wt. % total ethanol and propylene glycol.
Aspect 24. A packaged plurality of unwrapped hard candy product comprising a container comprising a moisture barrier material or packaged within a moisture barrier material; and a plurality of unwrapped hard candy product units housed within the container, the unwrapped hard candy product comprising a hydrophobic lubricant, a polyol having an equilibrium relative humidity less than 50%, wherein the unwrapped hard candy product has non-cohesive surface tack, an accelerated shelf life of greater than five weeks, and a microcrystalline outer layer disposed around an amorphous center.
Aspect 25. The packaged plurality of unwrapped hard candy product according to Aspect 24, wherein the polyol has a hygroscopicity of less than or equal to 10% at room temperature and 60% relative humidity.
Aspect 26. The packaged plurality of unwrapped hard candy product according to Aspect 24 or 2, wherein each unwrapped hard candy product units has a weight less than or equal to 1 gram, or 0.2 to 0.8 gram, or 0.5 to 0.7 gram.
Aspect 27. The packaged plurality of unwrapped hard candy product according to any one of Aspects 24 to 26, wherein the microcrystalline layer on the hard candy product unit has a crystal size less than 100 microns, or less than 50 microns, or less than 25 microns, or less than or equal to 20 microns.
Aspect 28. The packaged plurality of unwrapped hard candy product according to any one of Aspects 24 to 27, wherein the hydrophobic lubricant comprises MCT oil.
Aspect 29. The packaged plurality of unwrapped hard candy product according to any one of Aspects 24 to 28, wherein the polyol having an equilibrium relative humidity less than 50% comprises isomalt.
Aspect 30. The packaged plurality of unwrapped hard candy product according to any one of Aspects 24 to 29, wherein water is present in an amount less than or equal to 4 wt % based on the total weight of the hard candy product.
Aspect 31. The packaged plurality of unwrapped hard candy product according to any one Aspects 24 to 30, wherein the hard candy product further comprises a flavorant.
Aspect 32. The packaged plurality of unwrapped hard candy product according to any one of Aspects 24 to 31, wherein the hard candy product further comprises a colorant, a sensate, a food acid or salt thereof, a high intensity sweetener, a buffering agent, a functional agent, or a combination thereof.
Aspect 33. The packaged plurality of unwrapped hard candy product according to any one of Aspects 24 to 32, wherein the hydrophobic lubricant is present in an amount of 0.01 to 1.0 wt. %, specifically 0.05 to 0.9 wt. %, more specifically 0.1 to 0.7 wt. %, and yet more specifically 0.15 to 0.6 wt. % based on the total weight of the hard candy product unit.
Aspect 34. The packaged plurality of unwrapped hard candy product according to any one of Aspects 24 to 33, wherein the polyol having a hygroscopicity of less than or equal to 10% at room temperature and 60% relative humidity and an equilibrium relative humidity less than 50% is present in an amount of 80 to 99.9 wt. % specifically 92 to 99 wt. %, and yet more specifically 94 to 99 wt. %, based on the total weight of the hard candy product unit.
Aspect 35. A packaged plurality of unwrapped hard candy product, comprising: a container comprising a moisture barrier material or packaged within a moisture barrier material; and a plurality of unwrapped hard candy product units housed within the container, the hard candy product comprising greater than or equal to 90 wt % isomalt, flavorant, and 0.01 to 1 wt % MCT oil, and having a moisture content of less than or equal to 4 wt. %, specifically less than or equal to 3 wt. %; wherein each unit of hard candy product has a weight of less than or equal to 1 gram, specifically 0.2 to 0.8 gram, and more specifically 0.5 to 0.7 gram, a microcrystalline outer layer disposed around an amorphous center and weight percent is based on the total weight of the hard candy product unit, wherein the microcrystalline outer layer is invisible to the naked eye.
Aspect 36. The packaged plurality of unwrapped hard candy product according to Aspect 35, wherein the microcrystalline layer on the hard candy product unit has a crystal size less than 100 microns, or less than 50 microns, or less than 25 microns, or less than or equal to 20 microns.
Aspect 37. The packaged plurality of unwrapped hard candy product according to Aspect 35 or 36, wherein the unwrapped hard candy product has non-cohesive surface tack.
Aspect 38. The packaged plurality of unwrapped hard candy product according to any one of Aspects 35 to 37, wherein the unwrapped hard candy product has an accelerated shelf life of greater than five weeks.
Aspect 39. A method of making a packaged plurality of unwrapped hard candy product comprising: forming a plurality of unwrapped hard candy product units comprising a hydrophobic lubricant and a polyol having an equilibrium relative humidity less than 50%; conditioning the plurality of unwrapped hard candy product units at a relative humidity which is equal to the equilibrium relative humidity of the polyol+/−20%, specifically+/−10%, and 18 to 28° C. , specifically 20 to 25° C. for up to 4 days, specifically 24 to 72 hours; and packaging the unwrapped hard candy product units in a container, the container comprising a moisture barrier material or packaged within a moisture barrier material.
Aspect 40. The method of Aspect 39, wherein each unwrapped hard candy product unit has a weight less than or equal to 1 gram, or 0.2 to 0.8 gram, or 0.5 to 0.7 gram.
Aspect 41. The method of Aspect 39 or 40, wherein each unwrapped hard candy product unit has a microcrystalline layer after conditioning.
Aspect 42. The method of any one of Aspects 39 to 41, wherein the hydrophobic lubricant comprises MCT oil.
Aspect 43. The method of any one of Aspects 39 to 41, wherein the polyol having an equilibrium relative humidity less than 50% comprises isomalt.

As used herein the terms “comprising” (also “comprises,” etc.), “having,” and “including” is inclusive (open-ended) and does not exclude additional, unrecited elements or method steps. The singular forms “a,” “an,” and “the” include plural referents unless the context clearly dictates otherwise. The endpoints of all ranges directed to the same characteristic or component are independently combinable, and inclusive of the recited endpoint. The term “a combination thereof” is inclusive two or more components of the list. The term “homogeneous” refers to a uniform blend of the components. The term “or” means “and/or.” Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. The terms “first,” “second,” and the like, “primary,” “secondary,” and the like, as used herein do not denote any order, quantity, or importance, but rather are used to distinguish one element from another.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A hard candy product, comprising:
isomalt,
a flavorant, and
optionally an additional ingredient,
wherein the hard candy product is free of ethanol and propylene glycol, or substantially free of ethanol, propylene glycol, or both ethanol and propylene glycol.

2. The hard candy product of claim 1, comprising 0 to 0.05 wt. % total ethanol and propylene glycol based on the total weight of the hard candy product.

3. The hard candy product of claim 1, wherein the hard candy product is further
free of glycerol; or
substantially free of glycerol.

4. The hard candy product of claim 3, comprising 0 to 0.05 wt. % total glycerol based on the total weight of the hard candy product.

5. The hard candy product of claim 1, wherein the hard candy product is
free of linear and branched chain C₁-C₅ alkyl alcohols comprising 1, 2, or 3 hydroxy groups; or
substantially free of linear and branched chain C₁-C₅ alkyl alcohols comprising 1, 2, or 3 hydroxy groups.

6. The hard candy product of claim 5, comprising 0 to 0.05 wt. % total linear and branched chain C i-Cs alkyl alcohols based on the total weight of the hard candy product.

7. The hard candy product of claim 1, wherein the flavorant is free of ethanol and propylene glycol, or substantially free of ethanol, propylene glycol, or both ethanol and propylene glycol.

8. The hard candy product of claim 1, wherein the flavorant is free of glycerol or substantially free of glycerol.

9. The hard candy product of claim 1, wherein the flavorant is free of linear and branched chain C₁-C₅ alkyl alcohols comprising 1, 2, or 3 hydroxy groups; or
substantially free of linear and branched chain C₁-C₅ alkyl alcohols comprising 1, 2, or 3 hydroxy groups.

10. The hard candy product of claim 1, wherein the flavorant is a mint flavorant or a non-citrus, fruit flavorant.

11. The hard candy product of claim 1, wherein the flavorant comprises MCT oil, triacetin, or a combination thereof as a flavor carrier.

12. The hard candy product of claim 1, wherein the additional ingredient is MCT oil, a colorant, a sensate, a food acid or salt thereof, a high intensity sweetener, a buffering agent, a functional agent, or a combination thereof.

13. The hard candy product of claim 1, comprising water in an amount of less than or equal to 4 wt. % based on the total weight of the hard candy product.

14. A method of preparing a hard candy product of claim 1, comprising:
cooking a mixture of isomalt and water, optionally under vacuum, to achieve a moisture content at or below 4 wt. % based on the total weight of the cooked mass, or melting isomalt to form a cooked mass;
cooling the cooked mass and adding the flavorant and optional additional ingredient with mixing to form a melt;
forming the melt into the hard candy product,
wherein the hard candy product is free of ethanol and propylene glycol, or substantially free of ethanol, propylene glycol, or both ethanol and propylene glycol.

15. A method of extending the shelf life of an isomalt hard candy, comprising:
using a flavorant in the isomalt hard candy composition, wherein the flavorant is free of ethanol and propylene glycol, or substantially free of ethanol, propylene glycol, or both ethanol and propylene glycol; optionally the flavorant is further free of glycerol or further substantially free of glycerol.

16. A packaged plurality of unwrapped hard candy product comprising
a container comprising a moisture barrier material or packaged within a moisture barrier material; and
a plurality of unwrapped hard candy product units housed within the container, the unwrapped hard candy product comprising a hydrophobic lubricant, a polyol having an equilibrium relative humidity less than 50%, wherein the unwrapped hard candy product has non-cohesive surface tack, an accelerated shelf life of greater than five weeks, and a microcrystalline outer layer disposed around an amorphous center.

17. The packaged plurality of unwrapped hard candy product according to claim 16, wherein the polyol has a hygroscopicity of less than or equal to 10% at room temperature and 60% relative humidity.

18. The packaged plurality of unwrapped hard candy product according to claim 16, wherein each unwrapped hard candy product unit has a weight less than or equal to 1 gram.

19. The packaged plurality of unwrapped hard candy product according to claim 16, wherein the microcrystalline layer on the hard candy product unit has a crystal size less than 100 microns.

20. The packaged plurality of unwrapped hard candy product according to claim 16, wherein the hydrophobic lubricant comprises MCT oil.

21. The packaged plurality of unwrapped hard candy product according to claim 16, wherein the polyol having an equilibrium relative humidity less than 50% comprises isomalt.

22. The packaged plurality of unwrapped hard candy product according to claim 16, wherein water is present in an amount less than or equal to 4 wt % based on the total weight of the hard candy product.

23. The packaged plurality of unwrapped hard candy product according to claim 16, wherein the hard candy product further comprises a flavorant.

24. The packaged plurality of unwrapped hard candy product according to claim 16, wherein the hard candy product further comprises a colorant, a sensate, a food acid or salt thereof, a high intensity sweetener, a buffering agent, a functional agent, or a combination thereof.

25. The packaged plurality of unwrapped hard candy product according to claim 16, wherein the hydrophobic lubricant is present in an amount of 0.01 to 1.0 wt. % based on the total weight of the hard candy product unit.

26. The packaged plurality of unwrapped hard candy product according to claim 16, wherein the polyol having a hygroscopicity of less than or equal to 10% at room temperature and 60% relative humidity and an equilibrium relative humidity less than 50% is present in an amount of 80 to 99.9 wt. % based on the total weight of the hard candy product unit.

27. The packaged plurality of unwrapped hard candy product according to claim 16,
wherein the unwrapped hard candy product comprises greater than or equal to 90 wt % isomalt, flavorant, and 0.01 to 1 wt % MCT oil, and having a moisture content of less than or equal to 4 wt. %; wherein each unit of hard candy product has a weight of less than or equal to 1 gram, a microcrystalline outer layer disposed around an amorphous center and weight percent is based on the total weight of the hard candy product unit, wherein the microcrystalline outer layer is invisible to the naked eye.

28. A method of making a packaged plurality of unwrapped hard candy product comprising:
forming a plurality of unwrapped hard candy product units comprising a hydrophobic lubricant and a polyol having an equilibrium relative humidity less than 50%;
conditioning the plurality of unwrapped hard candy product units at a relative humidity which is equal to the equilibrium relative humidity of the polyol+/−20%, and 18 to 28° C., for up to 4 days; and
packaging the unwrapped hard candy product units in a container, the container comprises a moisture barrier material or is packaged within a moisture barrier material.

29. The method of claim 28, wherein each unwrapped hard candy product unit has a weight less than or equal to 1 gram.

30. The method of claim 29, wherein each unwrapped hard candy product unit has a microcrystalline layer after conditioning, the hydrophobic lubricant comprises MCT oil, and the polyol having an equilibrium relative humidity less than 50% comprises isomalt.
